(19) United States
(12) Patent Application Publication
(10) Pub. No.: US 2007/0082208 A1
(43) Pub. Date: Apr. 12, 2007

(54) Curable fiberglass binder comprising a beta-amino-ester or beta-amino-amide conjugate addition product

(76) Inventors: Kiarash Alavi Shooshtari, Littleton, CO (US); Diana Kim Fisler, Littleton, CO (US)

Correspondence Address: JOHNS MANVILLE, 10100 WEST UTE AVENUE, LITTLETON, CO, 80127, US

(21) Appl. No.: 11/245,669

(22) Filed: Oct. 7, 2005

(51) Int. Cl. C08F 22/04; B32B 27/34

(52) U.S. Cl. 428/474.4; 525/327.7

(57) ABSTRACT

A curable formaldehyde-free binding composition for use with fiberglass is provided. Such curable composition comprises a conjugate addition product of an amine and an unsaturated reactant in the form of a β-amino-ester or β-amino-amide intermediate. The composition when coated on fiberglass is cured to form a water-insoluble polyamide or polyimide binder which exhibits good adhesion to glass. In a preferred embodiment the fiberglass is in the form of building insulation. In other embodiments the product is a microglass-based substrate for use in a printed circuit board, battery separator, filter stock, or reinforcement scrim.

### BACKGROUND OF THE INVENTION

1. Field of the Invention

The subject invention pertains to an improved binding composition for use with fiberglass. More specifically, the invention pertains to an improved curable composition comprising a conjugate addition product of an amine and an unsaturated reactant in the form of a β-amino-ester or β-amino-amide intermediate which upon curing is capable of forming a water-insoluble polyamide or polyimide which displays good adhesion to glass. Once applied as a coating on the fiberglass, the binding composition is cured. The binder of the present invention is useful as a fully acceptable replacement for formaldehyde-based binders in non-woven fiberglass products.

2. Description of the Related Art

Fiberglass binders have a variety of uses ranging from stiffening applications where the binder is applied to woven or non-woven fiberglass sheet goods and cured, producing a stiffer product; thermo-forming applications wherein the binder resin is applied to a sheet or lofty fibrous product, following which it is dried and optionally B-staged to form an intermediate but yet curable product; and to fully cured systems such as building insulation.

Fibrous glass insulation products generally comprise matted glass fibers bonded together by a cured thermoset polymeric material. Molten streams of glass are drawn into fibers of random lengths and blown into a forming chamber where they are randomly deposited as a mat onto a traveling conveyor. The fibers, while in transit in the forming chamber and while still hot from the drawing operation, are sprayed with an aqueous binder. A phenol-formaldehyde binder has been used throughout the fibrous glass insulation industry. The residual heat from the glass fibers and the flow of air through the fibrous mat during the forming operation are generally sufficient to volatilize water from the binder, thereby leaving the remaining components of the binder on the fibers as a viscous or semi-viscous high solid liquid. The coated fibrous mat is transferred to a curing oven where heated air, for example, is blown through the mat to cure the binder and rigidly bond the glass fibers together.

Fiberglass binders used in the present sense should not be confused with matrix resins which are an entirely different and non-analogous field of art. While sometimes termed “binders”, matrix resins act to fill the entire interstitial space between fibers, resulting in a dense, fiber reinforced product where the matrix must translate the fiber strength properties to the composite, whereas “binder resins” as used herein are not space-filling, but rather coat only the fibers, and particularly the junctions of fibers. Fiberglass binders also cannot be equated with paper or wood product “binders” where the adhesive properties are tailored to the chemical nature of the cellulosic substrates. Many such resins are not suitable for use as fiberglass binders. One skilled in the art of fiberglass binders would not look to cellulosic binders to solve any of the known problems associated with fiberglass binders.

Binders useful in fiberglass insulation products generally require a low viscosity in the uncured state, yet possess characteristics so as to form a rigid thermoset polymeric binder for the glass fibers when cured. A low binder viscosity in the uncured state is required to allow the mat to be sized correctly. Also, viscous binders commonly tend to be tacky or sticky and hence they lead to the accumulation of fiber on the forming chamber walls. This accumulated fiber may later fall onto the mat causing dense areas and product problems. A binder which forms a rigid matrix when cured is required so that a finished fiberglass thermal insulation product, when compressed for packaging and shipping, will recover to its as-made vertical dimension when installed in a building.

From among the many thermosetting polymers, numerous candidates for suitable thermosetting fiberglass binder resins exist. However, binder-coated fiberglass products are often of the commodity type, and thus cost becomes a driving factor, generally ruling out resins such as thermosetting polyurethanes, epoxies, and others. Due to their excellent cost/performance ratio, the resins of choice in the past have been phenol-formaldehyde resins. Phenol-formaldehyde resins can be economically produced, and can be extended with urea prior to use as a binder in many applications. Such urea-extended phenol-formaldehyde binders have been the mainstay of the fiberglass insulation industry for years, for example.

Over the past several decades however, minimization of volatile organic compound emissions (VOCs) and hazardous air pollutants (HAPS) both on the part of the industry desiring to provide a cleaner environment, as well as by Federal regulation, has led to extensive investigations into not only reducing emissions from the current formaldehyde-based binders, but also into candidate replacement binders. For example, subtle changes in the ratios of phenol to formaldehyde in the preparation of the basic phenol-formaldehyde resole resins, changes in catalysts, and addition of different and multiple formaldehyde scavengers, has resulted in considerable improvement in emissions from phenol-formaldehyde binders as compared with the binders previously used. However, with increasingly stringent Federal regulations, more and more attention has been paid to alternative binder systems which are free from formaldehyde.

One such candidate binder system employs polymers of acrylic acid as a first component, and a polyol such as triethanolamine, glycerine, or a modestly oxyalkylated glycerine as a curing or “crosslinking” component. The preparation and properties of such poly(acrylic acid)-based binders, including information relative to the VOC emissions, and a comparison of binder properties versus urea-formaldehyde binders is presented in “Formaldehyde-Free Crosslinking Binders For Non-Wovens,” Charles T. Arkins et al., TAPPI Journal, Vol. 78, No. 11, pages 161-168, November 1995. The binders disclosed by the Arkins article, appear to be B-stageable as well as being able to provide physical properties similar to those of urea/formaldehyde resins.

U.S. Pat. No. 5,340,868 discloses fiberglass insulation products cured with a combination of a polycarboxy polymer, a-hydroxyalkylamide, and at least one trifunctional monomeric carboxylic acid such as citric acid. The specific polycarboxy polymers disclosed are poly(acrylic acid) polymers. See also, U.S. Pat. No. 5,143,582.

U.S. Pat. No. 5,318,990 discloses a fibrous glass binder which comprises a polycarboxy polymer, a monomeric trihydric alcohol and a catalyst comprising an alkali metal salt of a phosphorous-containing organic acid.

Published European Patent Application EP 0 583 086 A1 appears to provide details of polyacrylic acid binders whose cure is catalyzed by a phosphorus-containing catalyst system as discussed in the Arkins article previously cited. Higher molecular weight poly(acrylic acids) are stated to provide polymers exhibiting more complete cure. See also U.S. Pat. Nos. 5,661,213; 5,427,587; 6,136,916; and 6,221,973.

Some polycarboxy polymers have been found useful for making fiberglass insulation products. Problems of clumping or sticking of the glass fibers to the inside of the forming chambers during the processing, as well as providing a final product that exhibits the recovery and rigidity necessary to provide a commercially acceptable fiberglass insulation product, have been overcome. See, for example, U.S. Pat. No. 6,331,350. The thermosetting acrylic resins have been found to be more hydrophilic than the traditional phenolic binders, however. This hydrophilicity can result in fiberglass insulation that is more prone to absorb liquid water, thereby possibly compromising the integrity of the product. Also, the thermosetting acrylic resins now being used as binding agents for fiberglass have been found to not react as effectively with silane coupling agents of the type traditionally used by the industry increasing product cost. The addition of silicone as a hydrophobing agent results in problems when abatement devices are used that are based on incineration as well as additional cost. Also, the presence of silicone in the manufacturing process can interfere with the adhesion of certain facing substrates to the finished fiberglass material. Overcoming these problems will help to better utilize polycarboxy polymers in fiberglass binders.

Accordingly, in one aspect the present invention provides a novel, non-phenol-formaldehyde binder.

Another aspect of the invention provides a novel fiberglass binder which provides advantageous flow properties, the possibility of lower binder usage, the possibility of overall lower energy consumption, elimination of interference in the process by a silicone, and improved overall economics.

These and other aspects of the present invention will become apparent to the skilled artisan upon a review of the following description and the claims appended hereto.

### SUMMARY OF THE INVENTION

A curable composition for use in the binding of fiberglass is provided comprising a conjugate addition product of an amine and an unsaturated reactant in the form on a β-amino-ester or β-amino-amide intermediate which upon curing is capable of forming a water-insoluble polyamide or polyimide which exhibits good adhesion to glass.

A process for binding fiberglass is provided comprising applying to fiberglass a coating of a composition comprising a conjugate addition product of an amine and an unsaturated reactant in the form of a β-amino-ester or β-amino-amide intermediate, and thereafter curing the composition while present as a coating on the fiberglass to form a water-insoluble polyamide or polyimide which exhibits good adhesion to the fiberglass.

In a preferred embodiment the resulting fiberglass product is building insulation. In other embodiments the fiberglass product is a microglass-based substrate useful when forming a printed circuit board, battery separator, filter stock, or reinforcement scrim.

### DETAILED DESCRIPTION OF PREFERRED EMBODIMENTS

The novel fiberglass binder of the present invention is a curable composition comprising a conjugate addition product (i.e., Michael addition product) of an amine and an unsaturated reactant in the form of a β-amino-ester or β-amino-amide intermediate.

In accordance with one embodiment of the invention, reactants are selected which are capable of undergoing conjugate addition to form the requisite β-amino-ester which forms a water-insoluble polyamide upon curing. The amine can be aliphatic, cycloaliphatic, or aromatic, and linear or branched. The amine can be a mono-, di-, or multi-functional primary-amine, a di- or multi-functional secondary-amine, or a combination of a primary-amine and a secondary-amine. Other functionalities can optionally be present with the amine, such as alcohols, thiols, esters, amides, esthers, etc. Representative mono-primary amines include methylamine, ethylamine, ethanolamine, benzylamine, and mixtures of these. Methylamine is a preferred mono-primary amine for economic reasons. Representative diamines include 1,2-diethylamine, 1,3-propanediamine, 1,4-butanediamine, 1,5-pentanediamine, 1,6-hexanediamine, piperazine, 4,4′-xylenediamine, and mixtures of these. A preferred di-amine is 1,6-hexanediamine. Representative multifunctional amines include diethyltriamine, triethylenetetramine, tetraethylenepentamine, and mixtures of these.

In accordance with one embodiment of the invention, wherein a curable β-amino-ester is formed, the unsaturated reactant is an unsaturated ester or salt thereof. Representative unsaturated esters are esters of acids such as acrylic acid, methacrylic acid, crotonic acid, maleic acid, fumaric acid, and mixtures of these. More specific examples of suitable unsaturated esters or salts thereof are methylacrylate, ethylacrylate, methylmethacrylate, methylcrotonate, dimethylmaleate, methylethylmaleate, dimethylfumarate, triethyl ammonium acrylate, bis(triethyl ammonium)maleate, triethyl ammonium mono-methylmaleate, and mixtures of these.

In accordance with another embodiment of the invention, reactants are selected which are capable of undergoing conjugate addition to form the requisite α-amino-amide which forms a water-insoluble polyimide upon curing. In such an embodiment the amine is a diamine having at least one primary amine group. Representative amines that are suitable for use in such an embodiment include 1,2-diethylamine, 1,3-propanediamine, 1,4-butanediamine, 1,5-pentanediamine, 1,6-hexanediamine, α,α′-diaminoxylene, diethylenetriamine, triethylenetetramine, tetraethylenepentamine, and mixtures of these. A preferred diamines for use in this embodiment of the invention are 1,4-butanediamine and 1,6-hexanediamine.

In accordance with another embodiment of the invention, a curable β-amino-amide is formed through the selection of an unsaturated reactant that is an unsaturated anhydride, unsaturated carboxylic acid, unsaturated ester, and salts and mixtures of such reactants. Representative unsaturated reactants are maleic acid, fumaric acid, maleic anhydride, mono- and di-esters of maleic acid and fumaric acid, and salts and mixtures of these. Ammonium salts of the unsaturated acids of their monoesters conveniently can be utilized. A preferred unsaturated reactant for use in the second embodiment is maleic anhydride.

The β-amino-ester and β-amino-amide conjugate addition products can be readily formed by mixing the components in an aqueous medium at room temperature. The resulting addition products are either water-soluble, water-dispersible, or are present as an emulsion. Such addition products next can be applied to fiberglass as coating while present in any of the above forms. The conjugate addition products can be applied to fiberglass when dissolved in water and/or organic solvents, or when dispersed or emulsified.

The composition when applied to the fiberglass optionally can include adhesion prompters, oxygen scavengers, solvents, emulsifiers, pigments, fillers, anti-migration aids, coalescents, wetting agents, biocides, plasticizers, organosilanes, anti-foaming agents, colorants, waxes, suspending agents, anti-oxidants, crosslinking catalysts, secondary crosslinkers, and combinations of these.

The fiberglass that is coated with the composition according to the present invention may take a variety of forms and in a preferred embodiment is building insulation. In other embodiments the fiberglass is a microglass-based substrate useful in applications such as printed circuit boards, battery separators, filter stock, and reinforcement scrim.

The composition of the present invention can be coated on the fiberglass by a variety of techniques. In preferred embodiments these include spraying, spin-curtain coating, and dipping-roll coating. The composition can be applied to freshly-formed fiberglass, or to the fiberglass following collection. Water or other solvents can be removed by heating.

Thereafter the composition undergoes curing wherein a polyamide or polyimide coating is formed which exhibits good adhesion to glass. Such curing can be conducted by heating. Elevated curing temperatures on the order of 100 to 300° C. generally are acceptable. Satisfactory curing results are achieved by heating in an air oven at 200° C. for approximately 20 minutes.

The cured polyamide or polyimide at the conclusion of the curing step commonly is present as a secure coating on the fiberglass in a concentration of approximately 0.5 to 50 percent by weight of the fiberglass, and most preferably in a concentration of approximately 1 to 10 percent by weight of the fiberglass.

The present invention provides a formaldehyde-free route to form a securely bound formaldehyde-free fiberglass product. The binder composition of the present invention provides advantageous flow properties, the elimination of interference by a silane, and improved overall economics.

The following examples are presented to provide specific examples of the present invention. In each instance the thin glass plate substrate that receives the coating can be replaced by fiberglass. It should be understood, however, that the invention is not limited to the specific details set forth in the Examples.

### EXAMPLE 1

8.52 g of a 70% solution of 1,6-hexanediamine (HDA) in water were slowly added to 8.85 g of methylacrylate (MA) and stirring continued for one hour. The molar ratio of MA to HDA was 2:1, and a conjugate addition product in the form of a β-amino-ester was formed. Such product was a clear liquid of low viscosity. This liquid was next coated on a thin glass plate, and was cured for 20 minutes by heating at 200° C. A cured amber polyamide coating was formed that displayed excellent adhesion to the glass. The coating was hard and insoluble in water and common solvents.

### EXAMPLE 2

Example 1 was substantially repeated with the exception that 13.2 g of the 70% solution of 1,6-hexanediamine (HDA) in water were added to 8.76 g of methylacrylate (MA). The molar ratio of MA and HDA was 1:1. The resulting cured amber polyamide coating was flexible, was insoluble in water, and adhered well to the glass.

### EXAMPLE 3

9.43 g of methylacrylate (MA) were slowly added to a 8.5 g of a 40% solution of methylamine in water and stirring continued for one hour. The molar ratio of the reactants was 1:1, and a conjugate addition product in the form of a β-amino-ester was formed. Such product was a clear liquid of low viscosity. This liquid was next coated on a thin glass plate, and was cured for 20 minutes by heating at 200° C. A cured dark amber polyamide coating was formed that adhered well to the glass. The coating was flexible and displayed moderate resistance to water.

### EXAMPLE 4

9.43 g of methylacrylate (MA) were slowly added to 4.25 g of a 40% solution of methylamine in water and stirring continued for one hour. The molar ratio of MA to methylamine was 1:2 and a conjugate addition product in the form of a β-amino-ester was formed. Next 18.18 g of a 70% solution of 1,6-hexanediamine (HDA) were added and the mixture was stirred for 5 minutes during which time the conjugate addition product in the form of a β-amino-ester was modified to include HDA reactant. The molar ratio of adduct to HDA was 1:1. The resulting conjugate addition product was next coated on a thin glass plate, and was cured for 20 minutes by heating at 200° C. A cured amber polyamide coating was formed that was flexible and insoluble in water.

### EXAMPLE 5

9.8 g of maleic anhydride (MAn) were slowly added to 5.8 g of 1,6-hexanediamine (HDA) dissolved in 10 g of water and stirring continued for 30 minutes. The molar ratio of MAn to HDA was 2:1, and a conjugate addition product of a β-amino-amide was formed. Such product was a clear low viscosity liquid. This liquid was next coated on a thin glass plate, and was dried in an oven at 100° C. for 5 minutes, and was cured for 20 minutes by heating at 200° C. An amber polyamide coating was formed that displayed excellent adhesion to the glass. The coating was hard and was insoluble in water and in common solvents.

### EXAMPLE 6

8.28 g of a 70% solution of 1,6-hexanediamine (HDA) in water were slowly added to 11.6 g of maleic acid (MAc) dissolved in 10 g of water and stirring continued for one hour. The molar ratio of MAc to HDA was 2:1, and a conjugate addition product of a β-amino-amide was formed. Such product was a clear low viscosity liquid. This liquid was next coated on a thin glass plate, was dried in an oven at 100° C. for 5 minutes, and was cured for 20 minutes by heating at 200° C. An amber polyamide coating was formed that displayed excellent adhesion to the glass. The coating was hard and was insoluble in water and in common solvents.

### EXAMPLE 7

5.8 g of 1,6-hexanediamine (HDA) were added to 13.0 g of methyl maleate dissolved in 10 g of water and stirring continued for one hour. The molar ratio of methyl maleate to HDA was 2:1, and a conjugate addition product of a β-amino-amide was formed. The product was a clear low viscosity liquid. The liquid was next coated on a thin glass plate, was dried in an oven at 100° C. for 5 minutes, and was cured for 20 minutes by heating at 200° C. An amber polyamide coating was formed that displayed excellent adhesion to glass. The coating was hard and was insoluble in water and common solvents.

### EXAMPLE 8

9.8 g of maleic anhydride (MAn) were added to 8.8 g of 1,4-butanediamine dissolved in 10 g of water and stirring continued for one hour. The molar ratio of MAn to 1,4-butanediamine was 1:2, and a conjugate addition product of a β-amino-amide was formed. The product was a clear low viscosity liquid. The liquid was next coated on a thin glass plate, was dried in an oven at 100° C. for 5 minutes, and was cured for 20 minutes by heating at 200° C. An amber polyamide coating was formed that displayed excellent adhesion to glass. The coating was hard and was insoluble in water and common solvents.

The principles, preferred embodiments, and modes of operation of the present invention have been described in the foregoing specification. The invention which is intended to be protected herein, however, is not to be construed as limited to the particular forms disclosed, since these are to be regarded as illustrative rather than restrictive. Variations and changes may be made by those skilled in the art without departing from the spirit of the invention.

We claim:

1. A curable composition for use in the binding of fiberglass comprising a conjugate addition product of an amine and an unsaturated reactant in the form of a β-amino-ester or β-amino-amide intermediate which upon curing is capable of forming a water-insoluble polyamide or polyimide which exhibits good adhesion to glass.

2. A curable composition for use in the binding of fiberglass according to claim 1, wherein the unsaturated reactant is an unsaturated ester or salt thereof, and a β-amino-ester intermediate is formed that is capable upon curing of forming a water-insoluble polyamide which exhibits good adhesion to glass.

3. A curable composition for use in the binding of fiberglass according to claim 2, wherein said unsaturated ester is an ester of an acid selected from the group consisting of acrylic acid, methacrylic acid, crotonic acid, maleic acid, fumaric acid, and mixtures thereof.

4. A curable composition for use in the binding of fiberglass according to claim 2, wherein said unsaturated ester or salt thereof is selected from the group consisting of methylacrylate, ethylacrylate, methylmethacrylate, methylcrotonate, dimethylmaleate, methylethylmaleate, dimethylfumarate, triethyl ammonium acrylate, bis(triethyl ammonium)maleate, triethyl ammonium mono-methylmaleate, and mixtures thereof.

5. A curable composition for use in the binding of fiberglass according to claim 2, wherein said amine is a mono-primary amine.

6. A curable composition for use in the binding of fiberglass according to claim 5, wherein said mono-primary amine is selected from the group consisting of methylamine, ethylamine, ethanolamine, benzylamine, and mixtures thereof.

7. A curable composition for use in the binding of fiberglass according to claim 2, wherein said amine is methylamine.

8. A curable composition for use in the binding of fiberglass according to claim 2, wherein said amine is a di- or multi-functional primary or secondary amine.

9. A curable composition for use in the binding of fiberglass according to claim 8, wherein said di- or multi-functional primary or secondary amine selected from the group consisting of 1,2-diethylamine, 1,3-propanediamine, 1,4-butanediamine, 1,5-pentanediamine, 1,6-hexanediamine, piperazine, 4,4′-xylenediamine, diethylenetriamine, triethylenetetramine, tetraethylenepentamine, and mixtures thereof.

10. A curable composition for use in the binding of fiberglass according to claim 1, wherein the amine is a diamine having at least one primary amine group, and the unsaturated reactant is selected from the group consisting of unsaturated anhydrides, unsaturated carboxylic acids, and unsaturated esters, and salts and mixtures of these and a β-amino-amide intermediate is formed that is capable upon curing of forming a water-insoluble polyimide which exhibits good adhesion to glass.

11. A curable composition for use in the binding of fiberglass according to claim 10 wherein said amine is selected from the group consisting of 1,2-diethylamine, 1,3-propanediamine, 1,4-butanediamine, 1,5-pentanediamine, 1,6-hexanediamine, α,α′-diaminoxylene, diethylenetriamine, triethylenetetramine, tetraethylenepentamine, and mixtures thereof.

12. A curable composition for use in the binding of fiberglass according to claim 10, wherein said unsaturated reactant is selected from the group consisting of maleic acid, fumaric acid, maleic anhydride, mono- and di-esters of maleic acid, mono- and di-esters of fumaric acid, and salts and mixtures thereof.

13. A curable composition for use in the binding of fiberglass according to claim 10, wherein said unsaturated reactant is maleic anhydride.

14. A process for binding fiberglass comprising applying to fiberglass a coating of a composition comprising a conjugate addition product of an amine and an unsaturated reactant in the form of a β-amino-ester or β-amino-amide intermediate, and thereafter curing said composition while present as a coating on said fiberglass to form a water-insoluble polyamide or polyimide which exhibits good adhesion to said fiberglass.

15. A process for binding fiberglass according to claim 14, wherein said addition product is a β-amino-ester intermediate formed from an amine and an unsaturated ester or salt thereof, and a polyamide coating is formed on said fiberglass.

16. A process for binding fiberglass according to claim 15, wherein said unsaturated ester is an ester of an acid selected from the group consisting of acrylic acid, methacrylic acid, crotonic acid, maleic acid, fumaric acid, and mixtures thereof.

17. A process for binding fiberglass according to claim 15, wherein unsaturated ester or salt thereof is selected from the group consisting of methyacrylate, ethylacrylate, methylmethacrylate, methylcrotonate, dimethylmaleate, methylethylmaleate, dimethylfumarate, triethyl ammonium acrylate, bis(triethyl ammonium)maleate, triethyl ammonium mono-methylmaleate, and mixtures thereof.

18. A process for binding fiberglass according to claim 15, wherein said amine is a mono-primary amine.

19. A process for binding fiberglass according to claim 18, wherein said mono-primary amine is selected from the group consisting of methylamine, ethylamine, ethanolamine, benzylamine, and mixtures thereof.

20. A process for binding fiberglass according to claim 15, wherein said amine is a di- or multi-functional primary or secondary amine.

21. A process for binding fiberglass according to claim 20, wherein said di- or multi-functional primary or secondary amine is selected from the group consisting of 1,2-diethylamine, 1,3-propanediamine, 1,4-butanediamine, 1,5-pentanediamine, 1,6-hexanediamine, piperazine, 4,4′-xylenediamine, diethylenetriamine, triethylenetetramine, tetraethylenepentamine, and mixtures thereof.

22. A process for binding fiberglass according to claim 14, wherein said addition product is a β-amino-amide intermediate formed from a diamine having at least one primary amine group and an unsaturated reactant is selected from the group consisting of unsaturated anhydrides, unsaturated carboxylic acids, and unsaturated esters, and salts and mixtures thereof, and a polyimide coating is formed on said fiberglass.

23. A process for binding fiberglass according to claim 22, wherein said amine is selected from the group consisting of 1,2-diethylamine, 1,3-propanediamine, 1,4-butanediamine, 1,5-pentanediamine, 1,6-hexanediamine, α,α′-diaminoxylene, diethylenetriamine, triethylenetetramine, tetraethylenepentamine, and mixtures of these.

24. A process for binding fiberglass according to claim 22, wherein said unsaturated reactant is selected from the group consisting of maleic acid, fumaric acid, maleic anhydride, mono- and di-esters of maleic acid, mono- and di-esters of fumaric acid, and salts and mixtures of these.

25. A process for binding fiberglass according to claim 15, wherein said unsaturated reactant is maleic anhydride.

26. A curable composition for the binding of fiberglass according to claim 1, further comprising at least one component selected from the group consisting of adhesion promoters, oxygen scavengers, moisture repellants, solvents, emulsifiers, pigments, fillers, anti-migration aids, coalescents, wetting agents, biocides, plasticizers, organosilanes, anti-foaming agents, colorants, waxes, suspending agents, anti-oxidants, and crosslinking catalysts.

27. A formaldehyde-free fiberglass product formed by the process of claim 15.

28. A formaldehyde-free fiberglass product formed by the process of claim 22.

29. A fiberglass product according to claim 27 wherein the product is building insulation.

30. A fiberglass product according to claim 28 wherein the product is building insulation.

31. A fiberglass product formed by the process of claim 15, wherein the product is a microglass-based substrate useful for any of a printed circuit board, battery separator, filter stock, or reinforcement scrim.

32. A fiberglass product formed by the process of claim 22, wherein the product is a microglass-based substrate useful for any of a printed circuit board, battery separator, filter stock, or reinforcement scrim.
